(19) United States
(12) Patent Application Publication
(10) Pub. No.: US 2018/0089605 A1
(43) Pub. Date: Mar. 29, 2018

(54) ENHANCED RIDE SHARING USER EXPERIENCE

(71) Applicant: Intel Corporation, Santa Clara, CA (US)

(72) Inventors: Rajesh Poornachandran, Portland, OR (US); Rita H. Wouhaybi, Portland, OR (US)

(21) Appl. No.: 15/273,988

(22) Filed: Sep. 23, 2016

(51) Int. Cl. G06Q 10/06; G06Q 30/02

(52) U.S. Cl. CPC G06Q 10/06393; G06Q 30/0282

(57) ABSTRACT

Disclosed in some examples, are methods, systems, and machine readable mediums which provide for improved matching of drivers and passengers in ride sharing systems using automatically determined user contexts. A score may be generated for each particular nearby driver that describes a suitability of the passenger and the driver given their respective contexts. In some examples, the score may be generated through the use of machine learning techniques. A nearby driver may then be selected based upon (or at least based partially on) the score. The selected driver may then be routed to the passenger.

### TECHNICAL FIELD

Embodiments pertain to improving user experiences for ride sharing applications. Some embodiments relate to utilizing physical sensors to determine and apply emotional preferences to better match drivers and passengers.

### BACKGROUND

Ride sharing platforms such as UBER® and LYFT® provide a network-based platform, including a network based server and user applications for matching ride-seeking individuals (passenger users) with individuals providing rides (driver users). The platform includes ratings of both drivers and passengers in an attempt at providing a quality experience by allowing users to avoid bad drivers or passengers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a ride sharing service environment according to some examples of the present disclosure.

FIG. 2 shows a schematic of a ride sharing service according to some examples of the present disclosure.

FIG. 3 shows an example machine learning module according to some examples of the present disclosure.

FIG. 4 shows a flowchart of a method of a ride share service matching a passenger user to a driver user according to some examples of the present disclosure.

FIG. 5 shows a flowchart of a method for providing feedback about a driver user from a passenger user according to some examples of the present disclosure.

FIG. 6 shows a block diagram of an example computing device of a driver user or a passenger user or both according to some examples of the present disclosure.

FIG. 7 is a block diagram illustrating an example of a machine upon which one or more embodiments may be implemented.

### DETAILED DESCRIPTION

Reviews of one person's experience in this environment may not be an accurate representation of what a different person would experience. One reason is that the reviews are highly dependent on personal tastes and circumstances of the user (e.g., the driver or passenger leaving the review). For example, one driver may rate excellent for a first passenger, but that same driver may not be acceptable to a second passenger. For example, perhaps the driver was too talkative to the second passenger, whereas the first passenger is outgoing and is fine with small talk during the ride. Additionally, the personal taste of a user may depend on the user's context. For example, a passenger may be traveling with a child. In that instance, the user may be more offended by inappropriate music played by the driver than in an instance in which the passenger is traveling alone. As used herein a “user” is any user of the ride sharing system and includes passenger users and driver users.

Disclosed in some examples, are methods, systems, and machine readable mediums which provide for improved matching of drivers and passengers in ride sharing systems using automatically determined user contexts. A user's context describes the current situation and circumstances of the user. User context includes a user's emotions (happy, sad, normal), time of day (e.g., a user may have different likes/dislikes depending on the time of day), state of mind (drunk, etc.), day of week, location, traveling companions and their relationships, previous places they have visited and time spend in those places, and the like. For drivers, contexts may include emotions, time of day, state of mind, location, traveling companions, current driving style, music choices, music volume, vehicle cleanliness, odor, and the like. The system may utilize one or more sensors in a position to monitor the users (e.g., in a computing device of the user, or car of a driver) to determine information about the users' contexts. Contexts of drivers are determined based upon sensors in their automobile, their computing devices, and the like. Contexts may be monitored before, during, and after the ride. The system may utilize emotional responses and explicit feedback to train a model that predicts a compatibility score between the driver user and the passenger user given the user's contexts. This model may produce a score that describes a suitability of the passenger and the driver given their respective contexts (including their emotional responses) during a ride. This score may be published along with the review of both the driver and passenger to guide users in understanding the review. The score may also be utilized to analyze pre-ride contexts to select a suitable driver given the pre-ride contexts of the driver and passenger. Publishing a review, in some examples, includes making it available to other users on one or more user interfaces of the ride sharing service (e.g., a GUI).

In some examples, the ride sharing service may also utilize the context information to suggest one or more topics of conversation between the driver users and passenger users and provide these topics on one or more computing devices of these users. For example, if the passenger just came from a tennis match, the system may alert the driver that tennis may be an appropriate conversation topic. In some examples, the system may utilize microphones to capture user's speech which may be parsed to determine preferred topics. In other examples, preferred topics may be set via a user profile. In still other examples, the preferred topics may be an aspect of a user's review of another user—thus, a passenger may leave feedback that a driver user likes to talk about a certain subject.

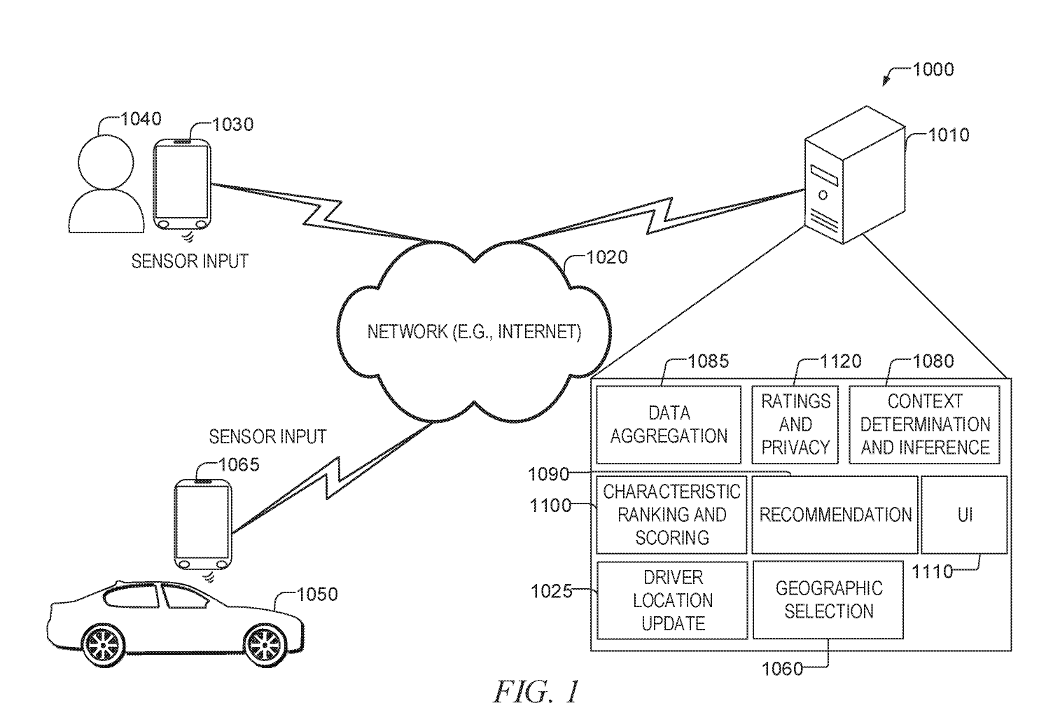

Turning now to FIG. 1, a ride sharing service environment 1000 is shown according to some examples of the present disclosure. A passenger user 1040 of the ride sharing service utilizes her device 1030 to access ride sharing server 1010 to request a ride. Device 1030 may have a dedicated application which may communicate with the ride sharing server 1010 using an Application Programming Interface (API) and may provide one or more graphical user interfaces. In other examples, device 1030 may utilize a general application (e.g., an internet browser application) which may contact ride sharing server 1010 and request, and receive, one or more user interface descriptors (e.g., one or more HyperText Markup Language (HTML) documents, Cascading Style Sheets (CSS) documents, eXtensible Markup Language (XML) documents, JavScript or other scripting language documents, and the like). The general application may then render these user interface descriptors to a display to provide the one or more graphical user interfaces. These graphical user interfaces, whether provided by a dedicated application or a general application rendering user interface descriptors may allow the user 1040 of device 1030 to request a ride from a driver user 1050. Device 1030 may be communicatively coupled to one or more sensors, such as a heart monitor, a blood pressure sensor, a pulse sensor, an insulin pump, a motion sensor, a microphone, a video camera, or the like. In some examples, these devices communicate with device 1030, which communicates sensor values to the ride sharing server 1010. Communications may occur over network 1020. In other examples, these devices may have functionality to communicate on their own to ride sharing server 1010.

Driver user 1050 also utilizes one or more computing devices 1065. Similarly, computing devices 1065 may be communicatively coupled to one or more sensors. Sensors may include audio, video, vehicle sensors, global positioning sensors, alcohol sensors, and the like. As with the sensors of the passenger user 1040, these sensors may communicate with the computing device 1065 of the driver user 1050 or may communicate independently to the ride sharing server 1010.

Ride sharing server 1010 may include a variety of modules. For example, a data aggregation module 1085. Data aggregation module 1085 may aggregate sensor input data (e.g., ride route, ride comfort, weather/terrain in ride route, user's biometric data obtained from wearables, videos, audio, and the like) and explicit user feedback (e.g., keyword descriptions entered by users) from users from sensors and computing devices of the users. As noted, input sources may include Internet of Things (TOT) sensing devices, cameras, microphones, user wearable devices, GPS devices, smartphones, tablets, laptops, desktops, and other sensors in a position to monitor the driver user or passenger user. Data aggregation policies (e.g., sampling interval) may be configurable. Aggregated data may be used to train a compatibility model based upon the context and the user's emotional response and feedback for that context. For example, driving through certain neighborhoods could make riders and drivers feeling nervous and anxious or after seeing a particular movie, riders might still be feeling happy or sad based on the movie. The data aggregation module 1085 may correlate a plurality of sensor readings and group them together into context events of the user. For example, the data aggregation module 1085 may aggregate all sensor data for a particular time window.

Ratings and privacy module 1120 may provide one or more user interfaces (UIs) to allow users to review and rate other users. Reviews may include textual reviews, star ratings, and the like. In some examples, the compatibility score may be published with a user's review. Ratings and privacy module 1120 may determine whether and to what extent user contexts may be shared as part of a published review of a user. Ratings and privacy module 1120 may publish one or more contexts of the driver and passenger during the ride, including emotional information. In some examples, ratings and privacy module 1120 may show or publish to the user their emotional status as part of the review (e.g., to remind the user of their emotional state during the ride when giving the review). The emotional state could also be annotated, for example showing an audio snippet right before there was a spike in emotional response showing anxiety or any other kind of negative emotion. Additionally ratings and privacy module 1120 may allow for user configurable privacy settings to allow a user to opt-in/opt-out to sensor data collection. Ratings and privacy module 1120 may also setup one or more cryptographic keys for communicating with computing devices of users to ensure security when collecting sensor data.

Context determination and inference module 1080 may receive context events and the raw sensor data to identify contexts of the user. In some examples, the context determination and inference module 1080 may utilize policies and rules for determining contexts. Various elements of a user's context may be inferred such as environmental contexts (weather conditions, pollen intensity, and the like), route context (traffic intensity, detours, neighborhood information, terrain information, and the like), emotional information (happy, sad, angry, and the like), ambience context (vehicle interior, cleanliness, safety hazards, and the like), and co-passenger behavior contexts (language, attitude, and the like). Context determination may infer the user's context from the context event sensor data using one or more algorithms such as emotion detection algorithms, if-then rules, policies and the like. For example, context determination and inference module 1080 may determine a user's context based upon if-then rules of the form if <sensor> is <value> then <context>. For example, if heartrate is elevated then user is anxious. In case one or more of the sensors produces conflicting results, the policies and rules may specify which of the sensor inputs is controlling. In some examples, a machine learning algorithm may learn a weighting for sensor inputs based upon past observations and whether or not the sensor reliably predicts the context. In some examples, the system may provide users with the inferred context and allow them to provide feedback on the inference.

Characteristic ranking and scoring module 1100 may infer one or more machine learned models based upon past contexts labeled with emotional responses and user provided feedback to provide appropriate recommendations. In some examples, the characteristic ranking and scoring module 1100 may feed the passenger user's context (including emotional state) during the ride along with the context of the driver user during the ride into the machine learning model to determine a compatibility score. The ratings and privacy module may publish this score along with a user's review. In some examples, the characteristic ranking and scoring module 1100 may feed the passenger user's pre-ride context along with pre-ride contexts of nearby driver users into the machine learning model to determine a plurality of compatibility scores. The recommendation module 1090 may utilize these scores to recommend an appropriate driver to a passenger who needs a ride. For example, the recommendation module 1090 may select the driver with the highest compatibility score.

In addition, the recommendation module 1090 may analyze one or more components of a passenger user's context and a driver user's context to provide recommendations, such as common topics of interest. In some examples, a cultural rule checker may be utilized that notifies the users of any offensive words or topics. This may be based upon user preferences. Users may opt in or out of these recommendations. In some examples, the characteristic ranking and scoring module 1100 may cooperate with ratings and privacy module 1120 to provide suggestions on improving ratings. For example, the system may inform a driver user 1050 that they often get negative ratings if they don't clean their vehicle regularly. Another example feedback may be informing a rider that they get lower ratings when they are drunk as their behavior is not pleasant in that state.

Driver location update module 1025 receives updates from drivers on their locations and updates their profiles. These locations may be utilized to select a driver to meet a passenger's needs. User Interface (UI) module 1110 may provide one or more user interfaces (such as a graphical user interface GUI) to provide the ride sharing service.

As noted, in some examples, ride sharing server 1010 may match a passenger user with a rider user based upon the user's pre-ride contexts. As previously noted, data aggregation module 1085 may receive information about the user's location, information about the user's context (either the context information itself or raw information—such as raw video—that is then used to determine the user's context), other criteria (such as the number of riders, vehicle preferences), and the like. Data aggregation module 1085 may package this information into discrete context events. Context events are packages of one or more sensor inputs that are related to a single context of the user. For example, all sensor inputs within a predetermined amount of time (e.g., the last 5 minutes) may be grouped together as a context event.

Ride sharing server 1010 may utilize this information to match the passenger user 1030 with a driver user 1050. For example, the geographic selection module 1060 may determine a candidate set of one or more drivers to fulfill the passenger's ride request based upon a proximity to the passenger. For example, the set may consist of drivers within a predetermined distance of the passenger. This is determined based upon the driver location updates received and processed by the driver location update modules 1025. In some examples, driver user 1050 with driver computing device 1065 may be in this set.

Characteristic ranking and scoring module 1100 may then utilize contexts of the driver users in the candidate set and the passenger user as determined by the context determination and inference module 1080 to calculate a compatibility score between drivers in this set and the passenger's current context based upon each driver's context information and the passenger's context information. The scoring may be based upon one or more machine-learned models. Machine learned models may be supervised or unsupervised. For example, a regression model, such as linear regression, may be built. Linear regression models the relationship between a dependent variable (the score) and one or more explanatory variables (e.g., the context information). The model may be fitted with a least squares or other approach based upon training data collected from the system operation. For example, previous rides, user contexts, driver contexts, driver vehicle features, and the like may be labelled with the passenger ratings and emotional responses given to those rides and used to fit the model. The system may utilize positive emotional responses as positive training data and negative emotional responses as negative data unless explicit user feedback indicates otherwise (e.g., a positive feedback coupled with a negative emotion may suggest that cases in which no feedback is given where the user has negative emotions may be a positive training example).

In the case of linear regression, the model may be a set of coefficients to apply to one of the contexts or features for use in a weighted summation algorithm. The coefficients represent a learned importance of a particular feature in comparison to the other features to the final compatibility. In some examples the score may depend on a compatibility between a passenger's context and a driver's context—that is, these variables may not be independent. In these examples, a predetermined set of if-then rules may be applied to produce a variable that is independent—for example, an emotional compatibility score that is then used as a variable in the regression model. For example, if the driver is in a good mood, and if the passenger is in a good mood then an emotional compatibility score may be high.

In some examples, in addition to the contexts, driver profile information and passenger profile information may also be used. For example, users may input a number of topical interests and other preferences. In some examples, these interests may be utilized as features input into the model to determine a match. In other examples, some of these features may be utilized when selecting the set of potential drivers (e.g., some preferences might disqualify drivers—e.g., a driver who is a smoker and a preference for non-smoking drivers).

In other examples, other supervised or unsupervised models may be utilized such as neural networks, decision trees, random forest algorithms, and the like. In still other examples, a machine learning algorithm may not be used and the driver and passenger contexts may be converted into a compatibility score using one or more predetermined rules. For example, the system may have a predetermined table which specifies a score for each possible driver and passenger context combination. In still other examples, a driver and a passenger's contexts may be tokenized into terms and each time a term matches between a driver and a passenger a compatibility score may be incremented. Certain terms from certain items of context may be weighted more heavily. The weightings may be determined by the users (e.g., preferences indicating which items are more important). Additionally, the driver and passenger profiles may be factored in similar to the way the context is for the non-machine learned approaches.

The recommendation module 1090 of the ride sharing service may then assign one or more of the drivers in the set to the passenger based (at least in part) on the scores. For example, the ride sharing service may assign the highest scoring driver to the passenger. In other examples, the ride sharing service may assign riders to passengers using a system-level approach. For example, there may be 20 passengers looking for rides and many may be competing for the same driver. For example, the system may see the following scores:

| | Driver 1 | Driver 2 |
|---|---|---|
| Passenger 1 | 90 | 25 |
| Passenger 2 | 92 | 70 |

In the above example, the system may seek to optimize the scores of passengers within a given geographical area (e.g., a city or neighborhood) and a given timeframe (e.g., 10 minutes). Thus, if passenger 1, passenger 2, driver 1 and driver 2 are all within the same geographical area, passenger 1 and passenger 2 are both seeking rides during the same general timeframe, and driver 1 and driver 2 are offering rides during that timeframe, the system may optimize the result across the set of all four. Thus, the system may chose driver 1 for passenger 1 and driver 2 for passenger 2. This yields a total score for all driver/passenger participants of 160. This compares to a case where the system had selected driver 1 for passenger 2 and driver 2 for passenger 1, the total score for all driver/passengers would be 117, which is less than 160. By choosing driver 1 for passenger 1 and driver 2 for passenger 2, this yielded the maximum compatibility for all riders and passengers.

During the ride share, the sensors may continue to monitor the contexts of the driver and passenger. Data aggregation module 1085, context determination and inference module 1080 may continue collecting data and generating contexts. For example, an emotional state of the passenger and driver users may be monitored. If the emotional state of the passenger user or driver user begins to go negative, the other user may be notified with a suggestion based upon the sensor data. For example, a decision tree may be created based upon historical feedback and historical sensor data which may analyze the sensor data to determine a likely cause of the user's dissatisfaction. This decision tree may recommend one or more actions to increase user satisfaction. Additionally, users may provide real-time explicit feedback through one or more GUIs of the ride sharing service which may be immediately shared with the other user. A during ride context of the users may also be determined and monitored, and a compatibility score may be generated (based upon the same model used in the pre-ride compatibility score) and published with a review and/or used to refine the model (to generate a better passenger-driver match).

After the ride, the users may leave feedback for each other using user interfaces (e.g., GUIs) provided by UI module 1110 and ratings and privacy module 1120. The feedback may include the compatibility score (either calculated pre-ride or during the ride). In some examples, this may be a star rating. In other examples, rather than a single star rating (as is popular in most ride sharing services) may comprise a plurality of facets—such as cleanliness of the ride, comfortability of the ride, driving style, comfort with the driver, and the like. The emotional state of the user during the ride may be utilized to supplement the review. For example, information on the emotional response or other contexts of the user may be published along with the review so that other users can determine the context of the review. In some examples, the users may have privacy settings that control whether and to what extent the context data is published.

In particular, an emotional state may be determined prior to the ride, and then during the ride. Negative changes in the user's emotional state may be attributed to the ride itself. For example, a rider who is happy and becomes angry during the ride may indicate that the driver was rude, late, or driving recklessly. A rider who is sad who becomes happy during the ride may indicate a pleasant experience. Similarly, a rider whose emotional state does not change may indicate that the ride was as expected.

For example, the system may utilize a tuple of starting emotions, emotions during the ride, and emotions immediately after the ride and use that tuple as an index into a table that provides a predetermined rating based upon the tuple. Thus each possible combination of <starting emotion, emotion during the ride, and emotions after the ride> and the corresponding rating may be predetermined. In other examples, the system may start with a predetermined rating and then add or remove stars or points based upon emotional reactions within the ride. In some additional examples, the ratings may comprise a plurality of rating facets. Each rating facet may correspond to a particular aspect of the ride. The tuple may index into a table and the table may indicate the rating for one or more of the plurality of facets.

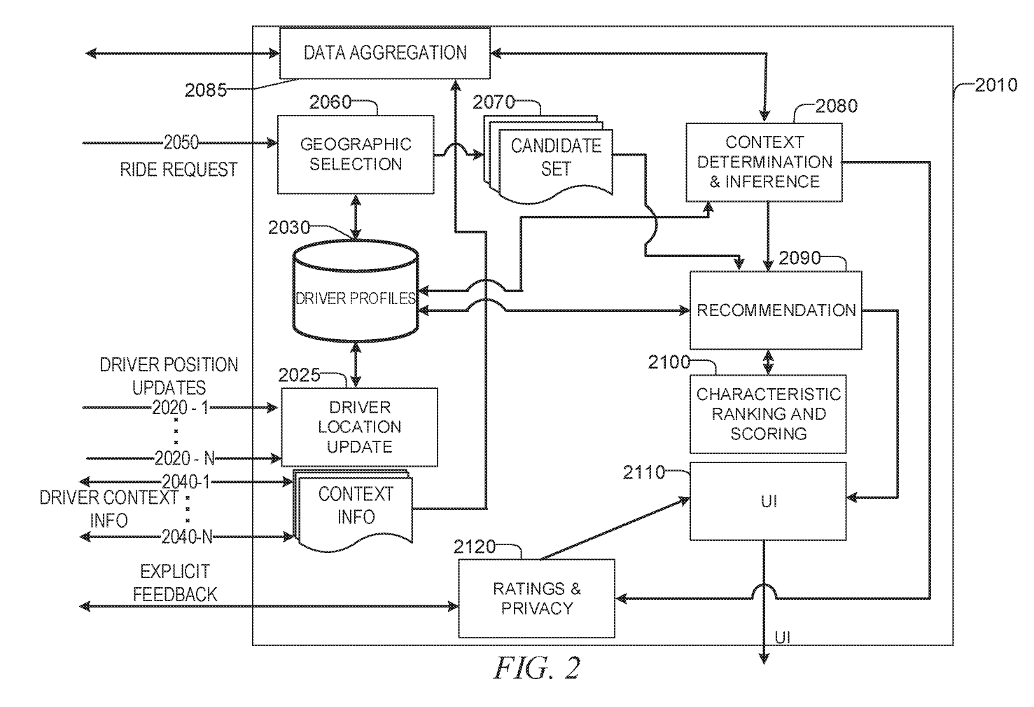

Turning now to FIG. 2, a schematic of a ride sharing service 2010 is shown according to some examples of the present disclosure. In some examples, the ride sharing service 2010 is an example embodiment of ride sharing service 1010 of FIG. 1 and the modules therein are examples of the same corresponding modules of FIG. 1. Driver position updates 2020-1-2020-n may be sent by one or more drivers over a network to update the ride sharing service 2010 of the geographical position of the one or more drivers. The updates may be periodically sent by a computing device of the driver. The updates may comprise the location of the driver or may comprise information that may be utilized by the ride sharing service 2010 to compute the location of the driver. These updates may be processed by the driver location update module 2025. In some examples, driver location update module 2025 may be an example embodiment of driver update module 1025 of FIG. 1. For example, the driver location update module 2025 may process the location information to determine a location of the driver. The location of the driver may be stored by the driver location update module 2025 along with other information about the drivers in a driver profiles data store 2030. Driver profiles data store 2030 may store information about drivers including: demographic information (e.g., name, age, address, languages spoken, and the like), vehicle information (make, model, year, size, condition, and the like), preference information (preferences for local vs long distance fares, types of passengers, smoking preferences, and the like), and/or the like.

Driver context information 2040-1-2040-n may comprise information about the context of one or more drivers. For example, information about driver context captured by the driver's computing devices (such as by using or communicating with one or more sensor devices). Other driver context information may include the driver's current vehicle, the radio station or music choices of the driver, the music volume of the driver, any indications the driver is smoking, the average g-forces experienced by the car in a recent time period (e.g., to determine the level of recklessness of the driver), and the like. This context information may be received by the data aggregation module 2085 which may aggregate this context information into context events which may be processed by the context determination and inference module 2080 and the result may be stored in the driver profiles data store 2030 for later matching with a passenger user, compatibility scoring, and recommendations. In some examples, data aggregation module 2085 may be an example embodiment of data aggregation module 1085.

Ride request 2050 includes geographic information of the rider user. For example, coordinates obtained from a global positioning system (GPS) on the rider-user's computing device. In some examples, the ride request 2050 includes other criteria, such as driver preferences, vehicle preferences, and the like. The geographic selection module 2060 utilizes this information and consults the driver profile data store 2030 to select one or more drivers to include in a candidate set of drivers 2070. For example, drivers that are within a predetermined radius of the passenger that are free and that meet the vehicle characteristics preferences of the passenger. The candidate set 2070 and the request is then fed to the recommendation module 2090. In some examples, geographic selection module 2060 may be an example embodiment of geographic selection module 1060 from FIG. 1.

Context determination and inference module 2080 may receive context events from data aggregation module 2085 from the passenger user and/or from the driver users. In some examples context determination and inference module 2080 may be an example embodiment of context determination and inference module 1080 from FIG. 1. Context determination and inference module 2080 may utilize this information to determine contexts of riders and passengers. Context event information may include video information from a video camera of a computing device (e.g., a video camera, a 3D camera, a sequences of images from the camera which may include 3D Depth map for better emotional characterization, and the like), information from a microphone of the computing device, information from an accelerometer of the computing device, information from wearable sensors, information from vehicle sensors, and the like. In some examples, the contexts may be determined from if-then rules using the context information as input. For example, if a detected volume level of music in the vehicle exceeds a threshold, then the driver's context is indicated to be “listening to loud music.” Rules may be in the form of if <sensor value> is <less than, greater than, or equal to> a <threshold value> then <context=value>. As another example rule: if <driver's g-force sensor average over the last 20 minutes> is greater than 0.9 g's, then driver is aggressive.

In some examples, video and audio may be utilized to determine one or more emotions of the users. For example, a method as described by the paper “Predicting Emotions in User-Generated Videos” by Yu-Gang Jiang, Baohan Xu, and Xiangyang Xue, Proceedings of the Twenty-Eigth AAAI Conference on Artificial Intelligence (www.aaai.org) 2014. Briefly, visual features, audio features, and attribute features are extracted from the videos and fed to a classifier (such as a kernel-level multimodal fusion classifier and a support vector machine) to determine emotions. Visual feature extraction may include utilizing Scale Invariant Feature Transform (SIFT), Histogram of Gradients (HOG), Self-Similarities (SSIM), GIST, Local Binary Patterns (LBP). Audio feature extraction may utilize a Mel-Frequency Cepstral Coefficients (MFCC), Energy Entropy, Signal Energy, Zero Crossing Rate, Spectral Rollof, Spectral Centroid, and Spectral Flux. Attribute feature extraction may include Classemes, ObjectBank, and SentiBank features.

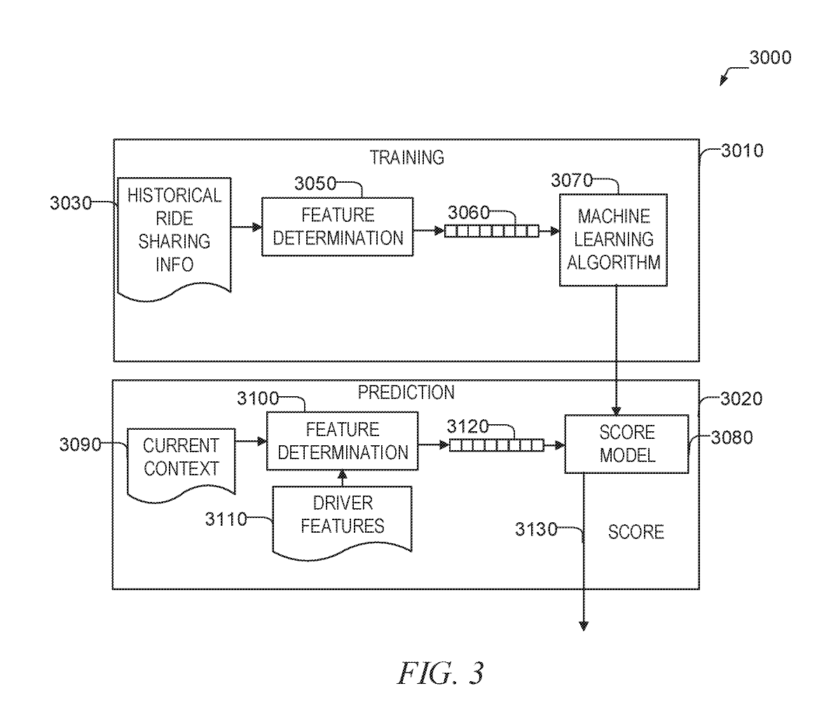

Contexts of the passenger and driver users may be fed to the recommendation module 2090 along with the candidate set 2070. In some examples recommendation module 2090 may be an example embodiment of recommendation module 1090 of FIG. 1. Recommendation module 2090 may score each driver using characteristic ranking and scoring module 2100 in the candidate set 2070 as to how well the driver and the driver's pre-ride context is compatible with the passenger and the passenger's pre-ride context. Characteristic ranking and scoring module 2100 may utilize one or more machine learning models to calculate this compatibility score using the passenger user's context and the driver user's context. FIG. 3 explains more on the machine learning aspect of the characteristic ranking and scoring module 2100. Once the candidate set of drivers are scored, the recommendation module 2090 may determine which driver to dispatch to the passenger user. In some examples, this may be the highest scoring driver. In other examples, the recommendation module 2090 may factor in other passenger users who are requesting rides in the same general area to maximize a total score across all passenger users requesting rides in the same general area at around the same time.

Recommendation module 2090 may provide the driver user selections for one or more passenger users to the UI module 2110. In some examples, UI module 2110 may be an example embodiment of UI module 1110 of FIG. 1. UI module 2110 may display or notify one or more driver users and passenger users of driver user selections through one or more user interfaces provided by the UI module 2110. UI module 2110 may provide one or more GUIs by providing one or more graphical user interface descriptors (one or more HTML documents, XML documents, CSS documents, scripting documents, and the like) which may be rendered by a general purpose application (such as an Internet browser) on a computing device of the passenger user or driver user. In other examples, the UI module 2110 may provide information which may be utilized by a dedicated application specific to the ride sharing service executing on computing devices of the driver users or passenger users. UI module 2110 may also provide one or more UIs to view and enter reviews, view and correct predicted contexts, and the otherwise provide feedback to the system.

As noted, context determination and inference module 2080 may determine a passenger user's context throughout the ride. For example, user context information may be delivered periodically throughout the ride. This information may be utilized by the context determination and inference module 2080 to periodically determine a user's context and their compatibility scores. For example, a user's emotional state. This information may be delivered to the ratings and privacy module 2120. In some examples, ratings and privacy module 2120 may be an example embodiment of ratings and privacy module 1120 of FIG. 1. Ratings and privacy module 2120 may track a passenger's user's emotional response throughout the ride. For example, a passenger whose emotional response becomes more negative then when they first accepted the ride the passenger user may be having a bad experience.

Ratings and privacy module 2120 may utilize the compatibility score during the ride as part of a user's review. In other examples, the ratings and privacy module 2120 may utilize a user's emotional response to predetermine a driver user's rating. In some examples, a driver user's rating is a single star-based rating, where a certain amount of stars is awarded. In other examples, the rating may have a plurality of constituent facets (components). In some examples, the constituent components may combine based upon a formula to determine an overall rating.

Context determination and inference module 2080 may continue to monitor the emotional state of the users during the ride. Changes (positive or negative) in the user's emotional state or compatibility score from before the ride may be attributed to the ride itself. For example, a rider who is happy and becomes angry during the ride may indicate that the driver was rude, late, or driving recklessly. A rider who is sad who becomes happy during the ride may indicate a pleasant experience. Similarly, a rider whose emotional state does not change may indicate that the ride was as expected. Recommendation module 2090 may provide one or more in-ride recommendations to improve an emotional satisfaction of the user.

In some examples, the system may periodically check in with the ride and upon changing from a positive emotion (as determined by a list of emotions) to a negative emotion (as determined by a second list of emotions), a star may be deducted from the rating. Changes in emotions to more positive emotions may add stars. At the end of the ride, the predicted score is the number of stars left. In other examples, stars may be determined from changes in the compatibility score from pre-ride to post-ride.

In other examples, the system may utilize a tuple of starting emotions, emotions during the ride, and emotions immediately after the ride and use that tuple as an index into a table that provides a predetermined rating based upon the tuple. Thus each possible combination of <starting emotion, emotion during the ride, and emotions after the ride> and the corresponding rating may be predetermined. In some additional examples, the ratings may comprise a plurality of rating facets. Each rating facet may correspond to a particular aspect of the ride. The tuple may index into a table and the table may indicate the rating for one or more of the plurality of facets.

Ratings and privacy module 2120 may pass the predicted ratings to the UI module 2110 for delivery of a GUI to allow the user to view the predicted ratings and modify the predicted ratings. The final ratings of the passenger user may then be delivered to the UI component 2110 to publish in association with a driver profile. In some examples, the logic of the ride sharing service may preserve a user's privacy by executing inside a tamper resistant Trusted Execution Environment (TEE).

FIG. 3 shows an example machine learning module 3000 according to some examples of the present disclosure. Machine learning module 3000 is one example portion of characteristic ranking and scoring module 2100 from FIG. 2. Machine learning module 3000 utilizes a training module 3010 and a prediction module 3020. Training module 3010 feeds historical ride sharing information 3030 into feature determination module 3050. The historical ride sharing information 3030 includes tuples of previous driver context information, rider context information, and passenger feedback and/or emotional responses (as a signal of how well the driver-passenger match was). Feature determination module 3050 determines one or more features 3060 from this information. Features 3060 are a subset of the information input and is information determined to be predictive of a response. In some examples, the features 3060 may be all the context information, sensor inputs, and the like. In some examples, some sensor inputs and context information may be combined according to one or more rules. For example, as previously described two dependent variables may be combined according to predetermined rules such that the resulting combination is an independent variable.

The machine learning algorithm 3070 produces a score model 3080 based upon the features 3060 and feedback associated with those features. For example, in situations in which a user provides a rating for the other user, the context of both users are used as a set of training data. In situations in which a user does not provide an explicit rating for the other user, the emotional response of the rider may be utilized as implicit feedback. Negative emotions may indicate a bad match with the other user and thus, this may be utilized as a negative training example. Positive emotions may indicate a good match and may be utilized as a positive training example. In some examples, the score model 3080 may be for the entire system (e.g., built of training data accumulated throughout the entire system, regardless of the users submitting the data), or may be built specific for each passenger user.

In the prediction module 3020, the current passenger context 3090, and the context of the driver 3110 may be input to the feature determination module 3100. Feature determination module 3100 may determine the same set of features or a different set of features as feature determination module 3050. In some examples, feature determination module 3100 and 3050 are the same module. Feature determination module 3100 produces features 3120, which are input into the score model 3080 to generate a score 3130. The training module 3010 may operate in an offline manner to train the score model 3080. The prediction module 3020, however, may be designed to operate in an online manner as each ride is completed.

It should be noted that the score model 3080 may be periodically updated via additional training and/or user feedback. The user feedback may be either feedback from users giving explicit feedback or from emotional responses from the ride.

The machine learning algorithm 3070 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method. In an example embodiment, a linear regression model is used and the score model 3080 is a vector of coefficients corresponding to a learned importance for each of the features in the vector of features 3060, 3120. To calculate a score, a dot product of the feature vector 3120 and the vector of coefficients of the score model 3080 is taken.

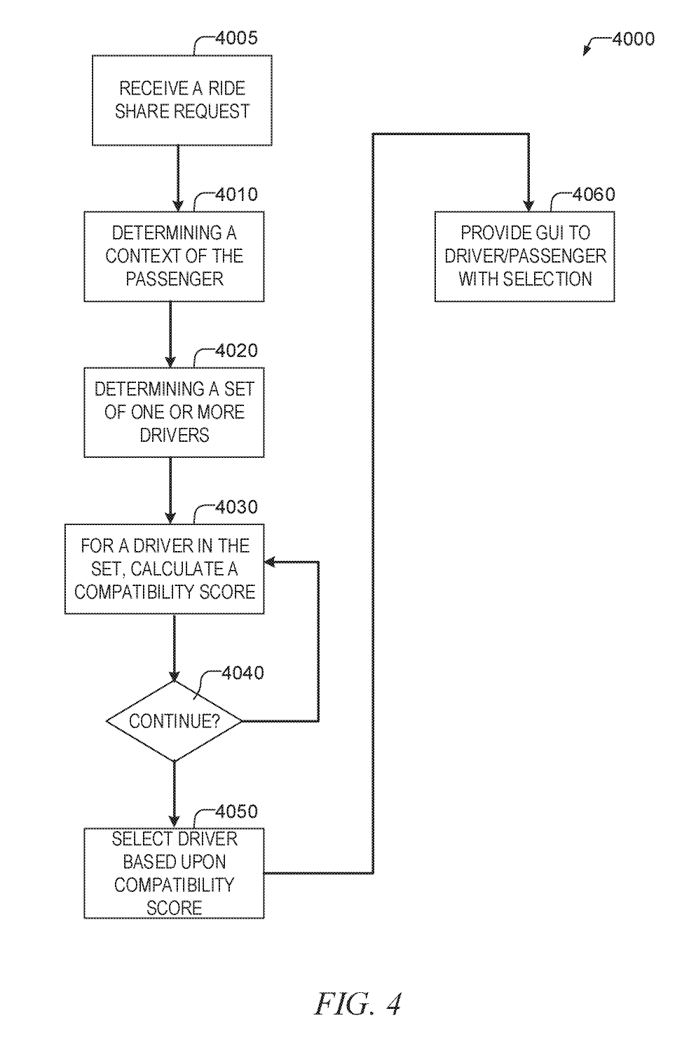

Turning now to FIG. 4, a flowchart of a method 4000 of a ride share service matching a passenger user to a driver user according to some examples of the present disclosure is shown. At operation 4005, the service receives a request from a passenger user for a ride. At operation 4010, the ride share service determines a context of the passenger user. This may include determining emotions of the passenger based upon one or more computing devices of the user, such as a mobile device, a wearable, or the like. The context may include a position of the user. At operation 4020, the system may determine a set of one or more candidate drivers. Candidate drivers may be determined based upon a set of one or more drivers that are within a predetermined geographic distance from the passenger user.

For a first respective driver in the set, the system calculates a compatibility score for the driver at operation 4030. The compatibility score may measure an expected compatibility between the passenger and their specific context and the first respective driver and the driver's context. At operation 4040, the system may calculate additional compatibility scores for different respective drivers in the set. In some examples, the system may calculate the compatibility scores for all the drivers in the set.

Once the compatibility scores are calculated, the system may select a driver based upon the compatibility scores at operation 4050. In some examples, the driver selected may be the driver with the highest compatibility score. At operation 4060, the system may notify the driver and passenger users of the driver assignment. In some examples, this may be through one or more graphical user interfaces. In other examples, this may be done through one or more notifications.

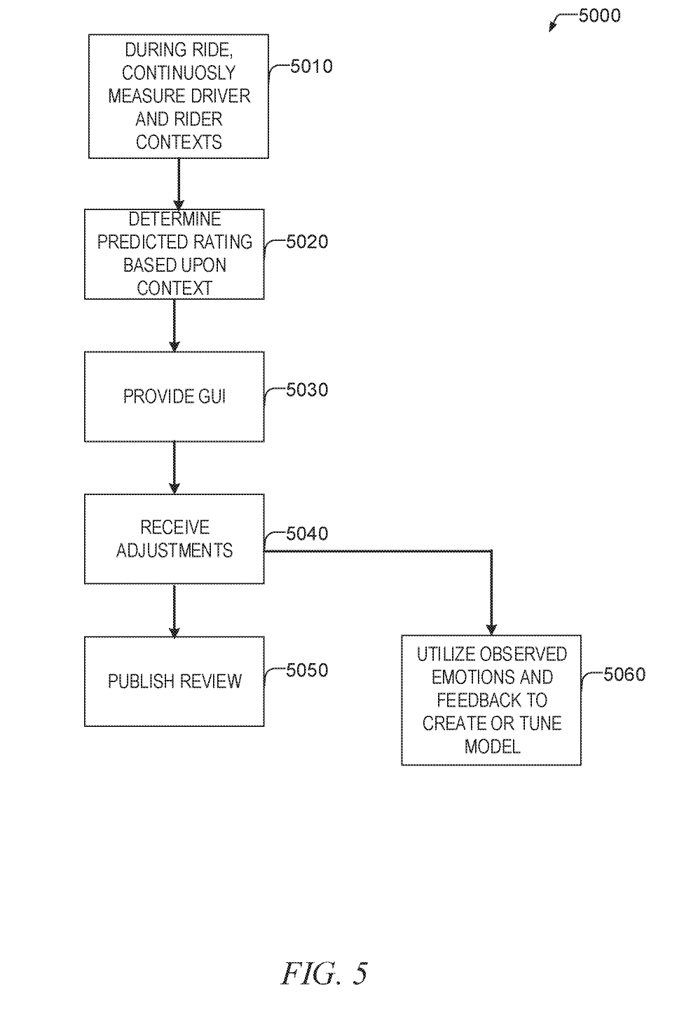

FIG. 5 shows a flowchart of a method 5000 for providing feedback about a driver user from a passenger user according to some examples of the present disclosure. At operation 5010, during the ride, the computing devices of the passenger users and the driver users monitor the users' respective contexts. The system may determine a start and end of the ride in a variety of ways. For example, the system may use physical proximity of the driver and the passenger to determine that the ride is ongoing. In other examples, the passenger or driver may input a start and end of the ride into their computing devices. In some examples, the driver's devices may monitor the passenger's context, and vice versa. This includes monitoring the emotions of the users (including the passenger and driver).

At operation 5020, the method may determine the predicted rating based upon the user's context before, during, and after the ride. For example, the system may utilize a tuple of starting emotions, emotions during the ride, and emotions immediately after the ride and use the tuple as an index into a table that provides a predetermined rating based upon the tuple. In other examples, the system may start with a predetermined rating and then add or remove stars or points based upon emotional reactions within the ride. In some additional examples, the ratings may comprise a plurality of rating facets. Each rating facet may correspond to a particular aspect of the ride. The tuple may index into a table and the table may indicate the rating for one or more of the plurality of facets.

At operation 5030 the method may provide a GUI to a passenger user to rate the ride at the completion of the ride. The GUI may present the predicted rating and the user may submit adjustments to the rating at operation 5040. These adjusted ratings may then be utilized at operation 5060 along with the observed emotions to tune the model to ensure a better match in the future. At operation 5050, the review may be published in one or more GUIs for other users. The ratings may be aggregated with other ratings of the driver user. In some examples, one or more of the determined contexts (e.g., emotions) of the rider passengers may be published with the review.

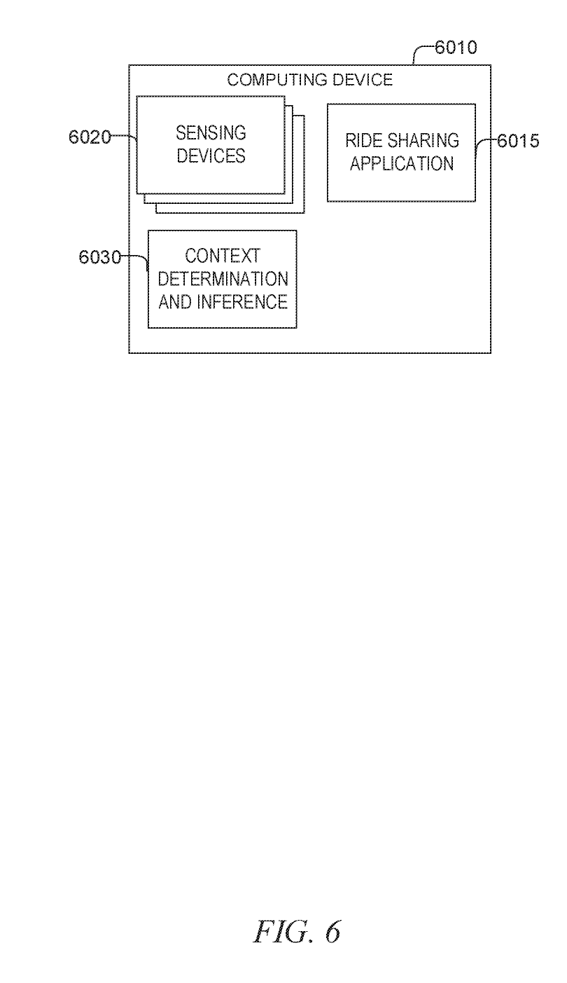

FIG. 6 shows a block diagram of an example computing device 6010 of a driver user or a passenger user or both according to some examples of the present disclosure. Computing device 6010 may include a mobile device (such as a smartphone, cellphone, laptop, tablet), a wearable (e.g., a smartwatch), a dash-mounted camera, a device connected to a data bus of an automobile (e.g., a device connected to an On Board Diagnostic (OBD) port, a device in communication with a controller area network bus (CANBUS)), or the like. Device 6010 may have, or be communicatively coupled to one or more sensing devices 6020. Sensing devices 6020 include: cameras, microphones, steering sensors, braking sensors, acceleration sensors, engine sensors, emissions sensors, speed sensors, airbag sensors, collision sensors, proximity sensors, backup sensors, moisture sensors, temperature sensors, roll sensors, pitch sensors, yaw-sensors, infra-red sensors, near field communication sensors, heartbeat sensors, blood pressure, skin temperature, spinal pressure, pulse sensors, blood oxygen level sensors, odor sensors, or the like.

In some examples, context determination and inference module 6030 may perform the functions of context determination and inference module 2080 of FIG. 2 on the computing device rather than the ride sharing service. In these examples, the context is determined by the computing device 6010 and sent to the ride sharing service. Ride sharing application 6015 may be a dedicated application or a general purpose application that renders one or more graphical user interfaces for providing the ride sharing application. GUIs for a passenger provide the ability to request a ride, pay for a ride, rate a ride, and the like. GUIs for a driver provide the ability to enter driver and vehicle information, set rates, set fare preferences, be dispatched, setup billing and be billed, and the like.

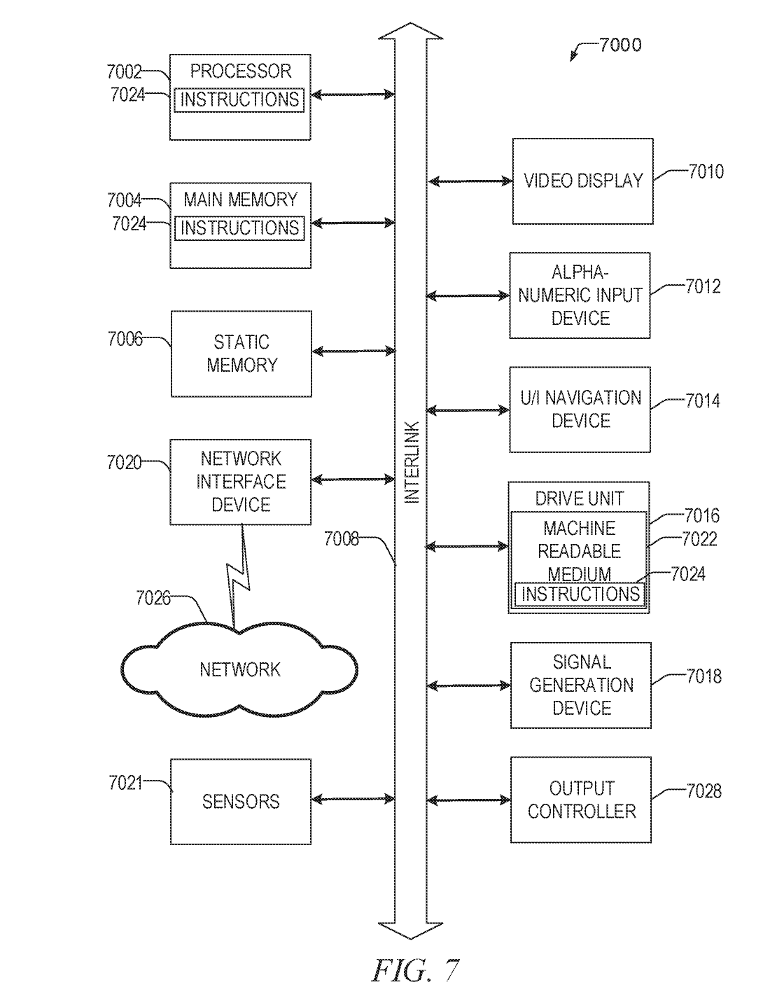

FIG. 7 illustrates a block diagram of an example machine 7000 upon which any one or more of the techniques (e.g., methodologies) discussed herein may perform. In alternative embodiments, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. Machine 7000 may be programmed to implement FIGS. 4 and 5, or be configured as shown in FIGS. 2 and 3 as the ride sharing service (or a part of ride sharing service). The machine 7000 may be a computing device of a passenger user, a computing device of a driver user, personal computer (PC), a tablet PC, a personal digital assistant (PDA), a mobile telephone, a smart phone, a web appliance, a network router, a computing device in an automobile, a security camera, an Internet of Things (IoT) device, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020. The machine 7000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output (MISO) techniques. In some examples, the network interface device 7020 may wirelessly communicate using Multiple User MIMO techniques.

### OTHER NOTES AND EXAMPLES

Example 1 is a device for matching a driver and a passenger in a network based service, the device comprising: a processor; a memory communicatively coupled to the processor and including instructions, which when performed by the processor cause the device to perform operations to: receive a ride share request from the passenger requesting a ride; determine, using a physical sensor on a computing device of the passenger, a context of the passenger; determine a set of drivers within a predetermined distance of the passenger; calculate a compatibility score measuring a compatibility of a respective driver of the set of drivers with the passenger based upon the context of the passenger and a context of the respective driver; select one of the set of drivers as an assigned driver based upon the compatibility score; and provide a respective Graphical User Interface (GUI) to the passenger and the assigned driver indicating a driver selection for the passenger.

In Example 2, the subject matter of Example 1 optionally includes wherein the operations to determine the context of the passenger comprises operations to determine an emotional state of the passenger.

In Example 3, the subject matter of any one or more of Examples 1-2 optionally include wherein the operations further comprise operations to: determine the context of the respective driver by determining an emotional state of the respective driver.

In Example 4, the subject matter of Example 3 optionally includes wherein the operations to determine the context of the respective driver comprises operations to determine an emotional state of the respective driver based upon information from a sensor of a computing device of the respective driver.

In Example 5, the subject matter of Example 4 optionally includes wherein the sensor is a video camera and the information from the sensor is a video.

In Example 6, the subject matter of any one or more of Examples 4-5 optionally include wherein the sensor is a video camera and the information comprises a sequence of one or more images from the camera.

In Example 7, the subject matter of any one or more of Examples 4-6 optionally include wherein the sensor is a video camera and the information comprises a three dimensional depth map.

In Example 8, the subject matter of any one or more of Examples 1-7 optionally include wherein the operations comprise operations to: determine, using the physical sensor on the computing device of the passenger, an in-ride context of the passenger; determine, using a physical sensor on a computing device of the assigned driver, an in-ride context of the assigned driver; calculate an in-ride compatibility score measuring a compatibility of the assigned driver with the passenger based upon the in-ride context of the passenger and the in-ride context of the assigned driver; provide to the passenger a Graphical User Interface (GUI) showing the in-ride context and which allows the passenger to input a review of the assigned driver; and publish the review along with the in-ride compatibility score.

In Example 9, the subject matter of any one or more of Examples 1-8 optionally include wherein the physical sensor is a camera, and wherein the operations to determine, using the physical sensor on the computing device of the passenger, the context of the passenger comprises operations to determine an emotional state of the passenger based upon a video recorded by the camera.

In Example 10, the subject matter of any one or more of Examples 1-9 optionally include wherein operations to calculate the compatibility score measuring the compatibility of the respective driver with the passenger based upon the context of the passenger and the context of the respective driver comprises operations to: use the context of the respective driver, the context of the passenger, and a model created by a machine learning algorithm to produce the compatibility score.

In Example 11, the subject matter of Example 10 optionally includes wherein the machine learning algorithm is a logistic regression algorithm.

In Example 12, the subject matter of any one or more of Examples 10-11 optionally include wherein the operations comprise operations to: access a training data set, the training data set comprising sets of in-ride contexts of drivers and corresponding passengers labeled with their emotional reactions to the ride; and train the model using the training data set as input to the supervised machine learning algorithm.

In Example 13, the subject matter of any one or more of Examples 1-12 optionally include wherein the operations to calculate the compatibility score measuring the compatibility of the respective driver with the passenger based upon the context of the passenger and the context of the respective driver comprises operations to: utilize a weighted summation algorithm to produce the compatibility score.

Example 14 is at least one machine readable medium including instructions, which when performed by a machine, causes the machine to perform operations for matching a driver and a passenger of a network based service comprising: receiving a ride share request from the passenger requesting a ride; determining, using a physical sensor on a computing device of the passenger, a context of the passenger; determining a set of drivers within a predetermined distance of the passenger; calculating a compatibility score measuring a compatibility of a respective driver of the set of drivers with the passenger based upon the context of the passenger and a context of the respective driver; selecting one of the set of drivers as an assigned driver based upon the compatibility score; and providing a respective Graphical User Interface (GUI) to the passenger and the assigned driver indicating a driver selection for the passenger.

In Example 15, the subject matter of Example 14 optionally includes wherein the operations of determining the context of the passenger comprises the operations of determining an emotional state of the passenger.

In Example 16, the subject matter of any one or more of Examples 14-15 optionally include wherein the operations further comprise: determining the context of the respective driver by determining an emotional state of the respective driver.

In Example 17, the subject matter of Example 16 optionally includes wherein the operations of determining the context of the respective driver comprises operations of determining an emotional state of the respective driver based upon information from a sensor of a computing device of the respective driver.

In Example 18, the subject matter of Example 17 optionally includes wherein the sensor is a video camera and the information from the sensor is a video.

In Example 19, the subject matter of any one or more of Examples 17-18 optionally include wherein the sensor is a video camera and the information comprises a sequence of one or more images from the camera.

In Example 20, the subject matter of any one or more of Examples 17-19 optionally include wherein the sensor is a video camera and the information comprises a three dimensional depth map.

In Example 21, the subject matter of any one or more of Examples 14-20 optionally include wherein the operations comprise: determining, using the physical sensor on the computing device of the passenger, an in-ride context of the passenger; determining, using a physical sensor on a computing device of the assigned driver, an in-ride context of the assigned driver; calculating an in-ride compatibility score measuring a compatibility of the assigned driver with the passenger based upon the in-ride context of the passenger and the in-ride context of the assigned driver; providing to the passenger a Graphical User Interface (GUI) showing the in-ride context and which allows the passenger to input a review of the assigned driver; and publishing the review along with the in-ride compatibility score.

In Example 22, the subject matter of any one or more of Examples 14-21 optionally include wherein the physical sensor is a camera, and wherein the operations of determining, using the physical sensor on the computing device of the passenger, the context of the passenger comprises operations of determining an emotional state of the passenger based upon a video recorded by the camera.

In Example 23, the subject matter of any one or more of Examples 14-22 optionally include wherein the operations of calculating the compatibility score measuring the compatibility of the respective driver with the passenger based upon the context of the passenger and the context of the respective driver comprises operations of: using the context of the respective driver, the context of the passenger, and a model created by a machine learning algorithm to produce the compatibility score.

In Example 24, the subject matter of Example 23 optionally includes wherein the machine learning algorithm is a logistic regression algorithm.

In Example 25, the subject matter of any one or more of Examples 23-24 optionally include wherein the operations comprise: accessing a training data set, the training data set comprising sets of in-ride contexts of drivers and corresponding passengers labeled with their emotional reactions to the ride; and training the model using the training data set as input to the supervised machine learning algorithm.

In Example 26, the subject matter of any one or more of Examples 14-25 optionally include wherein the operations of calculating the compatibility score measuring the compatibility of the respective driver with the passenger based upon the context of the passenger and the context of the respective driver comprises the operations of: utilizing a weighted summation algorithm to produce the compatibility score.

Example 27 is a method for matching a driver and a passenger of a network based service, the method comprising: receiving a ride share request from the passenger requesting a ride; determining, using a physical sensor on a computing device of the passenger, a context of the passenger; determining a set of drivers within a predetermined distance of the passenger; calculating a compatibility score measuring a compatibility of a respective driver of the set of drivers with the passenger based upon the context of the passenger and a context of the respective driver; selecting one of the set of drivers as an assigned driver based upon the compatibility score; and providing a respective Graphical User Interface (GUI) to the passenger and the assigned driver indicating a driver selection for the passenger.

In Example 28, the subject matter of Example 27 optionally includes wherein determining the context of the passenger comprises determining an emotional state of the passenger.

In Example 29, the subject matter of any one or more of Examples 27-28 optionally include determining the context of the respective driver by determining an emotional state of the respective driver.

In Example 30, the subject matter of Example 29 optionally includes wherein determining the context of the respective driver comprises determining an emotional state of the respective driver based upon information from a sensor of a computing device of the respective driver.

In Example 31, the subject matter of Example 30 optionally includes wherein the sensor is a video camera and the information from the sensor is a video.

In Example 32, the subject matter of any one or more of Examples 30-31 optionally include wherein the sensor is a video camera and the information comprises a sequence of one or more images from the camera.

In Example 33, the subject matter of any one or more of Examples 30-32 optionally include wherein the sensor is a video camera and the information comprises a three dimensional depth map.

In Example 34, the subject matter of any one or more of Examples 27-33 optionally include determining, using the physical sensor on the computing device of the passenger, an in-ride context of the passenger; determining, using a physical sensor on a computing device of the assigned driver, an in-ride context of the assigned driver; calculating an in-ride compatibility score measuring a compatibility of the assigned driver with the passenger based upon the in-ride context of the passenger and the in-ride context of the assigned driver; providing to the passenger a Graphical User Interface (GUI) showing the in-ride context and which allows the passenger to input a review of the assigned driver; and publishing the review along with the in-ride compatibility score.

In Example 35, the subject matter of any one or more of Examples 27-34 optionally include wherein the physical sensor is a camera, and wherein determining, using the physical sensor on the computing device of the passenger, the context of the passenger comprises determining an emotional state of the passenger based upon a video recorded by the camera.

In Example 36, the subject matter of any one or more of Examples 27-35 optionally include wherein calculating the compatibility score measuring the compatibility of the respective driver with the passenger based upon the context of the passenger and the context of the respective driver comprises: using the context of the respective driver, the context of the passenger, and a model created by a machine learning algorithm to produce the compatibility score.

In Example 37, the subject matter of Example 36 optionally includes wherein the machine learning algorithm is a logistic regression algorithm.

In Example 38, the subject matter of any one or more of Examples 36-37 optionally include accessing a training data set, the training data set comprising sets of in-ride contexts of drivers and corresponding passengers labeled with their emotional reactions to the ride; and training the model using the training data set as input to the supervised machine learning algorithm.

In Example 39, the subject matter of any one or more of Examples 27-38 optionally include wherein calculating the compatibility score measuring the compatibility of the respective driver with the passenger based upon the context of the passenger and the context of the respective driver comprises: utilizing a weighted summation algorithm to produce the compatibility score.

Example 40 is a device for matching a driver and a passenger of a network based service, the device comprising: means for receiving a ride share request from the passenger requesting a ride; means for determining, using a physical sensor on a computing device of the passenger, a context of the passenger; means for determining a set of drivers within a predetermined distance of the passenger; means for calculating a compatibility score measuring a compatibility of a respective driver of the set of drivers with the passenger based upon the context of the passenger and a context of the respective driver; means for selecting one of the set of drivers as an assigned driver based upon the compatibility score; and means for providing a respective Graphical User Interface (GUI) to the passenger and the assigned driver indicating a driver selection for the passenger.

In Example 41, the subject matter of Example 40 optionally includes wherein the means for determining the context of the passenger comprises means for determining an emotional state of the passenger.

In Example 42, the subject matter of any one or more of Examples 40-41 optionally include means for determining the context of the respective driver by determining an emotional state of the respective driver.

In Example 43, the subject matter of Example 42 optionally includes wherein the means for determining the context of the respective driver comprises means for determining an emotional state of the respective driver based upon information from a sensor of a computing device of the respective driver.

In Example 44, the subject matter of Example 43 optionally includes wherein the sensor is a video camera and the information from the sensor is a video.

In Example 45, the subject matter of any one or more of Examples 43-44 optionally include wherein the sensor is a video camera and the information comprises a sequence of one or more images from the camera.

In Example 46, the subject matter of any one or more of Examples 43-45 optionally include wherein the sensor is a video camera and the information comprises a three dimensional depth map.

In Example 47, the subject matter of any one or more of Examples 40-46 optionally include means for determining, using the physical sensor on the computing device of the passenger, an in-ride context of the passenger; means for determining, using a physical sensor on a computing device of the assigned driver, an in-ride context of the assigned driver; means for calculating an in-ride compatibility score measuring a compatibility of the assigned driver with the passenger based upon the in-ride context of the passenger and the in-ride context of the assigned driver; means for providing to the passenger a Graphical User Interface (GUI) showing the in-ride context and which allows the passenger to input a review of the assigned driver; and means for publishing the review along with the in-ride compatibility score.

In Example 48, the subject matter of any one or more of Examples 40-47 optionally include wherein the physical sensor is a camera, and wherein the means for determining, using the physical sensor on the computing device of the passenger, the context of the passenger comprises means for determining an emotional state of the passenger based upon a video recorded by the camera.

In Example 49, the subject matter of any one or more of Examples 40-48 optionally include wherein the means for calculating the compatibility score measuring the compatibility of the respective driver with the passenger based upon the context of the passenger and the context of the respective driver comprises: means for using the context of the respective driver, the context of the passenger, and a model created by a machine learning algorithm to produce the compatibility score.

In Example 50, the subject matter of Example 49 optionally includes wherein the machine learning algorithm is a logistic regression algorithm.

In Example 51, the subject matter of any one or more of Examples 49-50 optionally include means for accessing a training data set, the training data set comprising sets of in-ride contexts of drivers and corresponding passengers labeled with their emotional reactions to the ride; and means for training the model using the training data set as input to the supervised machine learning algorithm.

In Example 52, the subject matter of any one or more of Examples 40-51 optionally include wherein the means for calculating the compatibility score measuring the compatibility of the respective driver with the passenger based upon the context of the passenger and the context of the respective driver comprises: means for utilizing a weighted summation algorithm to produce the compatibility score.

What is claimed is:

1. A device for matching a driver and a passenger, the device comprising:
a processor and a memory communicatively coupled to the processor and including instructions, which when performed by the processor cause the device to perform operations to:
receive a ride share request from the passenger requesting a ride;
determine, using a physical sensor on a computing device of the passenger, a context of the passenger;
determine a set of drivers within a predetermined distance of the passenger;
calculate a compatibility score measuring a compatibility of a respective driver of the set of drivers with the passenger based upon the context of the passenger and a context of the respective driver;
select one of the set of drivers as an assigned driver based upon the compatibility score; and
provide a respective Graphical User Interface (GUI) to the passenger and the assigned driver indicating a driver selection for the passenger.

2. The device of claim 1, wherein the operations to determine the context of the passenger comprises operations to determine an emotional state of the passenger.

3. The device of claim 1, wherein the operations further comprise operations to: determine the context of the respective driver by determining an emotional state of the respective driver.

4. The device of claim 3, wherein the operations to determine the context of the respective driver comprises operations to determine an emotional state of the respective driver based upon information from a sensor of a computing device of the respective driver.

5. The device of claim 4, wherein the sensor is a video camera and the information from the sensor is a video.

6. The device of claim 4, wherein the sensor is a video camera and the information comprises a sequence of one or more images from the camera.

7. The device of claim 4, wherein the sensor is a video camera and the information comprises a three dimensional depth map.

8. At least one machine readable medium including instructions, which when performed by a machine, causes the machine to perform operations for matching a driver and a passenger of a network based service comprising:
receiving a ride share request from the passenger requesting a ride;
determining, using a physical sensor on a computing device of the passenger, a context of the passenger;
determining a set of drivers within a predetermined distance of the passenger;
calculating a compatibility score measuring a compatibility of a respective driver of the set of drivers with the passenger based upon the context of the passenger and a context of the respective driver;
selecting one of the set of drivers as an assigned driver based upon the compatibility score; and
providing a respective Graphical User Interface (GUI) to the passenger and the assigned driver indicating a driver selection for the passenger.

9. The at least one machine-readable medium of claim 8, wherein the operations comprise:
determining, using the physical sensor on the computing device of the passenger, an in-ride context of the passenger;
determining, using a physical sensor on a computing device of the assigned driver, an in-ride context of the assigned driver;
calculating an in-ride compatibility score measuring a compatibility of the assigned driver with the passenger based upon the in-ride context of the passenger and the in-ride context of the assigned driver;
providing to the passenger a Graphical User Interface (GUI) showing the in-ride context and which allows the passenger to input a review of the assigned driver; and
publishing the review along with the in-ride compatibility score.

10. The at least one machine-readable medium of claim 8, wherein the physical sensor is a camera, and wherein the operations of determining, using the physical sensor on the computing device of the passenger, the context of the passenger comprises operations of determining an emotional state of the passenger based upon a video recorded by the camera.

11. The at least one machine-readable medium of claim 8, wherein the operations of calculating the compatibility score measuring the compatibility of the respective driver with the passenger based upon the context of the passenger and the context of the respective driver comprises operations of:
using the context of the respective driver, the context of the passenger, and a model created by a machine learning algorithm to produce the compatibility score.

12. The at least one machine-readable medium of claim 11, wherein the machine learning algorithm is a logistic regression algorithm.

13. The at least one machine-readable medium of claim 11, wherein the operations comprise:
accessing a training data set, the training data set comprising sets of in-ride contexts of drivers and corresponding passengers labeled with their emotional reactions to the ride; and
training the model using the training data set as input to the supervised machine learning algorithm.

14. The at least one machine-readable medium of claim 8, wherein the operations of calculating the compatibility score measuring the compatibility of the respective driver with the passenger based upon the context of the passenger and the context of the respective driver comprises the operations of:
utilizing a weighted summation algorithm to produce the compatibility score.

15. A method for matching a driver and a passenger of a network based service, the method comprising:
receiving a ride share request from the passenger requesting a ride;
determining, using a physical sensor on a computing device of the passenger, a context of the passenger;
determining a set of drivers within a predetermined distance of the passenger;
calculating a compatibility score measuring a compatibility of a respective driver of the set of drivers with the passenger based upon the context of the passenger and a context of the respective driver;
selecting one of the set of drivers as an assigned driver based upon the compatibility score; and
providing a respective Graphical User Interface (GUI) to the passenger and the assigned driver indicating a driver selection for the passenger.

16. The method of claim 15, wherein determining the context of the passenger comprises determining an emotional state of the passenger.

17. The method of claim 15, further comprising: determining the context of the respective driver by determining an emotional state of the respective driver.

18. The method of claim 17, wherein determining the context of the respective driver comprises determining an emotional state of the respective driver based upon information from a sensor of a computing device of the respective driver.

19. The method of claim 18, wherein the sensor is a video camera and the information from the sensor is a video.

20. The method of claim 18, wherein the sensor is a video camera and the information comprises a sequence of one or more images from the camera.
